(19) United States
(12) Patent Application Publication
(10) Pub. No.: US 2018/0244988 A1
(43) Pub. Date: Aug. 30, 2018

(54) SURFACE MODIFIED SILICON QUANTUM DOTS

(71) Applicant: NDSU RESEARCH FOUNDATION, Fargo, ND (US)

(72) Inventors: Philip Boudjouk, Fargo, ND (US); Guruvenket Srinivasan, Alexandria, VA (US); Kenneth Anderson, Fargo, ND (US); Justin Hoey, Fargo, ND (US); Robert A. Sailer, West Fargo, ND (US)

(73) Assignee: NDSU RESEARCH FOUNDATION, Fargo, ND (US)

(21) Appl. No.: 15/898,655

(22) Filed: Feb. 18, 2018

Related U.S. Application Data
(63) Continuation of application No. PCT/US2016/047904, filed on Aug. 19, 2016.
(60) Provisional application No. 62/207,846, filed on Aug. 20, 2015.

(51) Int. Cl. C09K 11/59; C09K 11/02; C01B 33/021

(52) U.S. Cl. CPC C09K 11/59; C01B 33/021; C09K 11/02

(57) ABSTRACT

Methods for producing surface functionalized silicon nanoparticles like Si-QDs using a continuous gas-phase synthesis by direct pyrolysis of aerosolized higher order liquid silanes like cyclohexasilane (Si₆H₁₂) or cyclopentasilane (Si₅H₁₀) to produce nanoscale particles are provided. The methods permit control over the particle characteristics i.e., crystallinity, core-shell, size and surface chemistry of Si nanostructures and allow the tuning of the band gap (absorption) and manipulation of photo responsive properties. A wide variety of modifications can be performed using the hydrogen (H) or hydroxyl (OH) groups attached to silicon atoms on the particle surface. The coupling of different molecules or complexes directly to the silicon atoms of the particles allows the engineering of desirable optical, chemical or biological activity to the particles or can act as linkers to agglomerate particles or form porous films.

### CROSS-REFERENCE TO RELATED APPLICATIONS

This application is a 35 U.S.C. § 111(a) continuation of PCT international application number PCT/US2016/047904 filed on Aug. 19, 2016, incorporated herein by reference in its entirety, which claims priority to, and the benefit of, U.S. provisional patent application Ser. No. 62/207,846 filed on Aug. 20, 2015, incorporated herein by reference in its entirety. Priority is claimed to each of the foregoing applications.

The above-referenced PCT international application was published as PCT International Publication No. WO 2017/062105 on Apr. 13, 2017 and republished on Jun. 1, 2017, which publications are incorporated herein by reference in their entireties.

### STATEMENT REGARDING FEDERALLY SPONSORED RESEARCH OR DEVELOPMENT

This invention was made with Government support under grant number DE-FC36-08G088160 awarded by the Department of Energy and under grant number N00014-15-1-0065 awarded by the Office of Naval Research. The Government has certain rights in the invention.

### INCORPORATION-BY-REFERENCE OF COMPUTER PROGRAM APPENDIX

Not Applicable

### BACKGROUND

### 1. Technical Field

The present technology pertains generally to synthesis schemes and methods for producing functionalized silicon based nanostructures and materials, and more particularly to compositions and methods for the synthesis of silicon-based materials using aerosolization of liquid hydrosilane(s) as a base substrate for surface functionalization.

### 2. Background Discussion

Quantum dots (QD) are tiny man-made crystals that are invisible to the human eye and typical microscopes. A human hair is 10,000 times wider than a quantum dot. The size of the quantum dot confers special physical, chemical and electronic properties that are not obtainable with typical macro and micro sized particles. Size control is highly desirable because it is a tool for fine tuning the particle properties. There is a need to control the size of SiQDs at the very small end of the spectrum, from 1.5 nm to 50 nm in this newly developing field.

Because of their novel physiochemical properties, quantum dots have been investigated for use in many different consumer and biomedical applications. For example, conventional quantum dots have been studied as potential nanoprobes to replace several of the organic dyes used in certain biomedical and veterinary diagnostics. However, despite the many benefits of using QDs in such product applications, the toxicity of many conventional quantum dot materials has hampered their utilization for such applications. The concerns about toxicity are predominantly based upon the composition of nonsilicon-based QDs, which most commonly comprises a cadmium-based core and zinc sulfide shell. The proposed, intentional exposure of humans to biomedical applications of QDs (such as imaging) has raised trepidation about using quantum dots for such commercial applications. In addition, the difficulties of imbuing multifunctional properties to nonsilicon-based QDs and/or heterogeneity has raised concerns about their use in environmental tests and assays, e.g., detection of heavy metals, organic molecules, and other contaminants of commercial interest.

Silicon quantum dots (Si-QDs) have been shown to be less toxic than organic based light emitting molecules (chromophores). The PL emission of Si-QDs observed thus far can be broadly classified into two regions; near UV (NUV) to aqua (300 nm to 500 nm) and green to near—IR (NIR) (500 nm to 950 nm). The color tunable emission of Si-QDs enables their use in several applications including not only light emitting devices, but also solar cells, photodetectors and biomedical imaging. The ability to engineer the structure (crystallinity, core-shell, etc.), size and surface chemistry of Si nanostructures will allow the tuning of the band gap (absorption) and tweaking of photo responsive properties.

Synthesis of Si-QDs has been achieved by top-down or bottom-up approaches. In the former, bulk Si is controllably fragmented into nanostructures using chemical and physical methods or their combinations, while in bottom-up approaches gaseous silane or organo-silanes are reduced to form Si-QDs using thermal, laser and plasma methods in the gas-phase. Si-QDs are also obtained by the reduction of silanes in super-critical fluids or liquids. High temperature (875° C.-1200° C.) gas-phase pyrolysis or thermal reduction of monosilane (SiH₄) for the production of Si particles is well known. However, high decomposition temperatures of SiH₄, difficulties associated with inefficient particle collection (particle adhesion to the reactor wall due to thermophoresis) and low yields limit this approach. Laser pyrolysis of SiH₄ to produce Si-QDs addressed some of these issues but still requires additional steps such as etching, size-sorting etc. Without exception, known processes for synthesizing Si-QDs require post-synthesis steps for surface passivation using suitable organic groups, to stabilize and prevent both photo-oxidation and aggregation in solution.

There is a need for new methods of synthesis of silicon quantum dots and a need for new methods of particle surface functionalization in order to reduce toxicity and improve compatibility while instilling desirable multifunction, physiochemical properties that permit use of quantum dots in biomedical diagnostics, environmental testing, and other commercial applications. The present technology satisfies these needs and is generally an improvement in the art.

### BRIEF SUMMARY

The technology described herein provides an apparatus and methods for producing functionalized silicon nanomaterials such as nanoparticles (Si-NPs) and smaller materials including silicon quantum dots (Si-QDs) or Si-nanocrystals (Si-NCs), referred to collectively as “nanoparticles.” Generally, the apparatus and methods for producing functionalized silicon nanostructures have two subsystems: one for producing Si-QD's or other nanoparticles and the second for functionalizing the particle surfaces. By controlling the chemistry of the starting materials and the reaction conditions it is possible to control the nanostructure size and morphology of the Si-NPs, Si-QDs or Si-NCs that are produced. The process provides control over particle size and control over surface features that allow for further nanoparticle modifications. Careful analyses of the nanoparticles showed that the particles produced by the process have “chemical hooks” in the form of hydrogen (H) or hydroxyl (OH) groups attached to silicon atoms on the particle surface. This feature allows for very efficient coupling to a broad spectrum of reagents.

The nanoparticle/quantum dot producing subsystem has an apparatus with a droplet generator, such as an injector or aerosolizer or nebulizer, which is capable of creating droplets from a source of a liquid silane precursor in flow of a carrier gas. The liquid silane droplets are preferably aerosolized cyclohexasilane (CHS, Si₆H₁₂), cyclopentasilane (CPS, Si₅H₁₀), neopentasilane (NPS), or other liquid silane compositions at atmospheric pressure.

The liquid droplets that emerge from the droplet generator are directed through a reaction zone that converts the droplets to nano-scale particles such as quantum dots by heating or by irradiation. An additional flow gas or gases may be introduced to increase the vaporization of the liquid silane aerosol droplets during flight to further facilitate nanoparticle formation.

The nanoparticles can be collected and separated by size or the whole range of particle sizes that are produced can be used. The material collector of the apparatus may employ different methods for isolating the particles produced by the reaction zone including a grid/filter or liquid bubbler to collect the synthesized materials.

The second subsystem provides for the modification of the outer surfaces the silicon structures. A wide variety of modifications can be performed using the hydrogen (H) or hydroxyl (OH) groups attached to silicon atoms on the particle surface.

The modifications can include the coupling of a variety of different molecules or complexes directly to the silicon atoms of the particle or through the hydroxyl group. These molecules include metal and non-metal atoms; alkyl, alkenyl and alkynal carbon groups; aromatic family groups, heteroatom chains; amine family groups; phosphine family groups; ketone family groups; aldehyde family groups, and thiol family groups etc.

In other embodiments, the modifiers may be a molecule or complex that is coupled to the metal or other atoms that are attached directly to the silicon particle surface. The molecules joined to the metals can be alkyl family groups; aromatic family groups, amine family groups; phosphine family groups; thiol family groups and heteroatom chains, for example.

The particles may also be designed with modifiers that link the particles together. In one embodiment, the attached molecule is a linking molecule that can react with other molecules or particle surface groups to link the particles together. In other embodiments, the particles are linked by bridges or spacing molecules such as alkanes, alkenes, alkynes, or heteroatom chains, etc. The linking molecules can also be functionalized with the similar modifications as described above.

The particles may also be modified by attaching atoms or groups of atoms with biological activity to the SiQD surface. For example, modifiers can be attached that reduce or enhance toxicity towards a variety of materials ranging from molecules or materials toxic to living organisms to molecules or materials that have therapeutic properties towards a variety of diseases or ailments. These attachments could include surfactants, proteins, or other molecules with specific activity.

The modifiers and particles can also act as tags or diagnostic complexes. For example, cadmium-free silicon quantum dots can be produced that can be “activated” in such a way that they respond to chemicals and other environmental stimuli. Whereas most quantum dots emit light based on being excited with a specific wavelength of light, the functionalized SiQDs can emit light based on exposure to acids, bases, heavy metals, and toxic nonmetals, and other chemicals. In other words, the light emissions from the activated SiQDs can occur with chemical triggers, not just excitation by light exposures.

It can be seen that the activated SiQDs have commercial potential as sensors and diagnostics in such commercial applications as manufacturing, oil exploration and production, the preparation, storage, and transportation of food preparation, environmental testing, and human and veterinary medicine.

According to one aspect of the technology, a method is provided for synthesis of functionalized amorphous or crystalline Si nanoparticles using the combination of aerosol formation, heating zone and surface functionalization by modifying hydrogen or hydroxyl groups on the particle surfaces.

Another aspect of the technology is to provide a method for producing Si based porous thin films of amorphous or crystalline silicon nanoparticles linked together by linking bridges or spacers, which may also have chemical or biological activity.

Another aspect of the technology is to provide an apparatus and method for producing functionalized nanoparticles that may be the sensor for biomedical diagnostics or environmental tests such as the detection of heavy metals, acidity or basicity levels or other contaminants.

According to one aspect of the technology, a method is provided for producing quantum dots and similar nanostructures that have characteristics and surface functionality that can be controlled.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWING(S)

The technology described herein will be more fully understood by reference to the following drawings which are for illustrative purposes only:

FIG. 1A is a schematic representation of an apparatus for aerosol mediated nanoparticle production according to one embodiment of the technology described herein.

FIG. 1B is a detail view of the heater and hot zone within the box shown in FIG. 1A.

FIG. 2A-2B is a schematic view representing the process of silicon particle formation and surface modification of hydrogen and hydroxyl groups with modifiers according to one fabrication method.

FIG. 3A is a schematic representation of a functionalized silicon particle with modifiers coupled directly to the particle through reactions with surface hydrogen or hydroxyl groups according to one embodiment of the technology.

FIG. 3B is a schematic representation of a functionalized silicon particle with active modifiers coupled to the particle through intermediate metal or nonmetal atoms previously reacted with surface hydrogen or hydroxyl groups according to another embodiment of the technology.

FIG. 4A is a schematic representation of a functionalized silicon particle with modifiers coupled directly to the particle through reactions with surface hydrogen or hydroxyl groups that link two particles together according to one embodiment of the technology.

FIG. 4B is a schematic representation of a functionalized silicon particle with a bridge or spacer linking two particles together coupled to each particle directly or through an intermediate metal or nonmetal atom previously reacted with particle surface hydrogen or hydroxyl groups according to another embodiment of the technology.

FIG. 4C is a schematic representation of a functionalized silicon particle with a bridge or spacer linking two particles together formed from the joining of two modifiers that are coupled to each particle directly or through an intermediate metal or nonmetal atom previously reacted with particle surface hydrogen or hydroxyl groups according to another embodiment of the technology.

FIG. 5 is a graph of the temperature profile across the “hot-zone” corresponding to reactor lengths of 6 cm and 12 cm of the reactor shown in detail in FIG. 1B.

### DETAILED DESCRIPTION

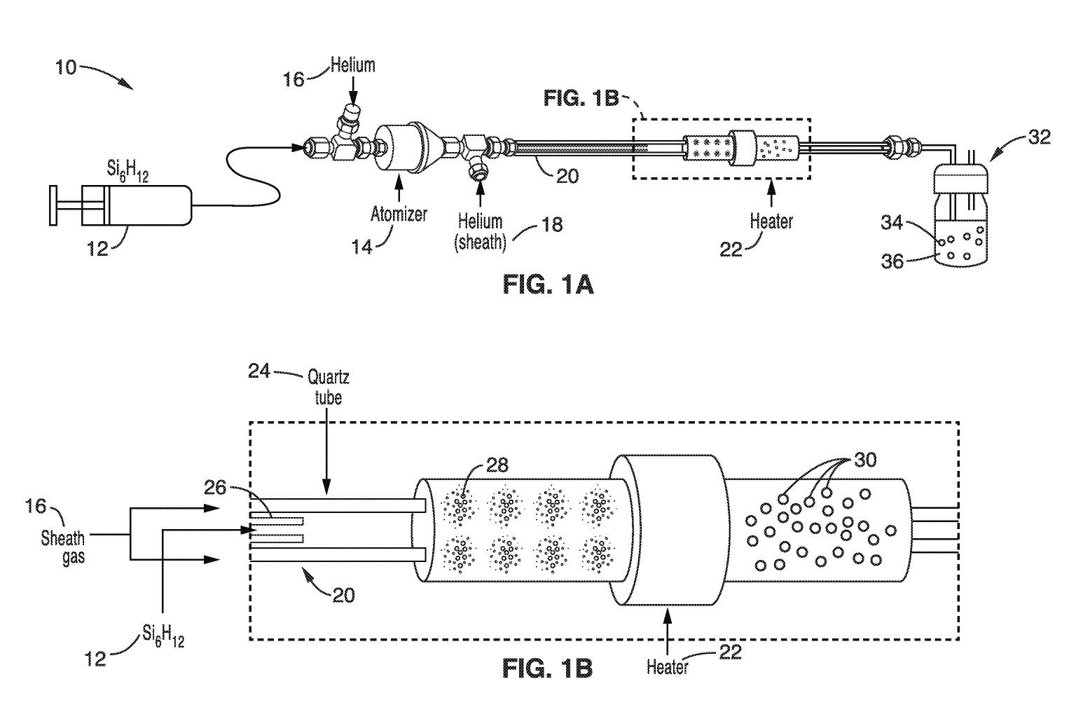

Referring more specifically to the drawings, for illustrative purposes, embodiments of the methods and resulting structures are generally shown. Several embodiments of the technology are described generally in FIG. 1 through FIG. 5 to illustrate the system, devices and methods. It will be appreciated that the methods may vary as to the specific steps and sequence and the system and devices may vary as to structural details without departing from the basic concepts as disclosed herein. The method steps are merely exemplary of the order that these steps may occur. The steps may occur in any order that is desired, such that it still performs the goals of the claimed technology.

Turning now to FIG. 1A and FIG. 1B, one preferred embodiment 10 of an apparatus for fabricating functionalized nanoparticles is generally shown to illustrate one suitable structure and fabrication method according to the technology. In the embodiment 10 shown in FIG. 1A, the general procedure is to produce silicon nanoparticles of desired sizes and surface features by controlling the fabrication conditions and then functionalizing the nanoparticle surfaces. It can be seen that the structural and functional features of the particles can be controlled through the selection of the fabrication conditions and materials.

The silicon nano or micro scale structures that are preferably produced using direct injection of cyclohexasilane (CHS, Si₆H₁₂) or cyclopentasilane (CPS, Si₅H₁₀) into the droplet generator of the apparatus with an injector 12 shown schematically in FIG. 1A. The syringe pump injector 12 is used to inject the precursor silane solution in the device at a defined rate and volume.

The droplet generator section has an injector or aerosolizer or nebulizer 14 structure that is capable of creating very small droplets 28. The apparatus is preferably capable of producing SiQDs and controlling size to form groups of p

articles in ranges of approximately 0.5 nm to 1.5 nm, 1.5 nm to 15 nm, 15 nm to 30 nm, 30 nm to 50 nm, and 50 nm to 100 nm and 100 nm to 200 nm for different applications.

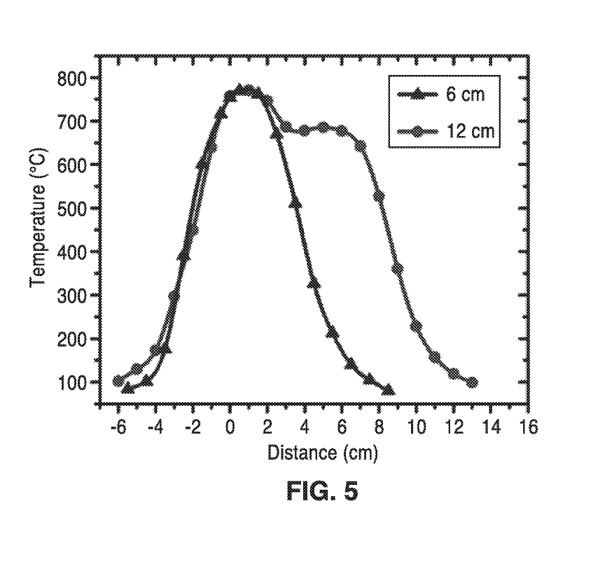

In the embodiment shown in FIG. 1A and FIG. 1B, the droplet generator 20 uses a primary carrier gas 16 and a sheath gas 18 from a source of suitable gases such as nitrogen, helium or argon. The gases provide a flow of gases to carry droplets 28 produced by the droplet generator 20 through the system to a heating chamber 24 with a temperature controlled hot zone provided by one or more heaters 22. The temperature profiles across the “hot-zone” corresponding to the reactor lengths of 6 cm and 12 cm are presented in FIG. 5.

The reaction hot zone of the heating chamber 24 in the apparatus may have an elevated temperature and/or electromagnetic radiation exposure or a combination of the two. In another embodiment, the second carrier gas or gases is pre-heated so that the atomized droplets are heated by the gas and vaporized.

As shown in the detailed view of FIG. 1B, the emitter of the droplet generator 20 has a central tube 26 that produces droplets 28 that flow through the hot zone 24 at a selected rate (residency time), volume and temperature to effectively convert the droplets 28 to particles 30.

The particles 30 are collected by a material collector 32 and prepared for surface functionalization. The material collector 32 shown in the embodiment of FIG. 1A is a bubbler that uses liquid 36 to collect the synthesized materials. Here, the particles and carrier gases form bubbles 34 in the liquid 36. The material collector 32 of the apparatus may also employ a method for isolating the particles produced by the reaction zone that utilizes a grid or filter.

Accordingly, the size and surface characteristics of the silicon nanostructures such as (Si-NPs), (Si-QDs) or (Si-NCs) that are produced by the apparatus can be selected through the selection of the drop size, temperature and dimensions of the hot-zone, time of laser exposure or residence time in the hot zone, characteristics of the carrier gas or gases and the identity of the initial silane materials and solvents. For example, the morphology of the particles such as Si-QD dots that are produced can be determined by the selection of droplet size and precursor composition. Surface passivation of the quantum dots may take place in flight and can also take place within the bubbler with the use of a suitable passivating media.

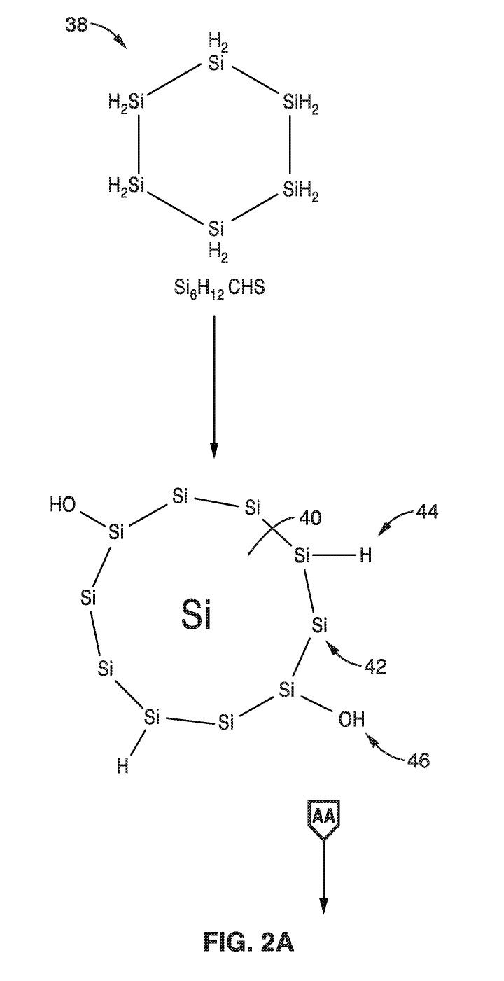

The process of particle fabrication and functionalization is shown schematically in FIG. 2. The liquid silane 38 precursor is converted to silicon nanoparticles 40 and collected. Analysis of the silicon particles 40 produced by the apparatus indicated that the surface of the particles have open silicon atoms 42 and silicon atoms with “chemical hooks” in the form of hydrogen (H) groups 44 or hydroxyl (OH) 46 attached to silicon atoms on the surface.

The chemical hook aspect of the particle surfaces allows for very efficient linking to a broad spectrum of reagents and materials including inorganic, organic and bioactive materials. Some modifiers 48 can attach to the particles through reaction with the hydrogen group. Other modifiers 50 can attach to the silicon atoms in the particle through the oxygen atom of the hydroxyl group 46.

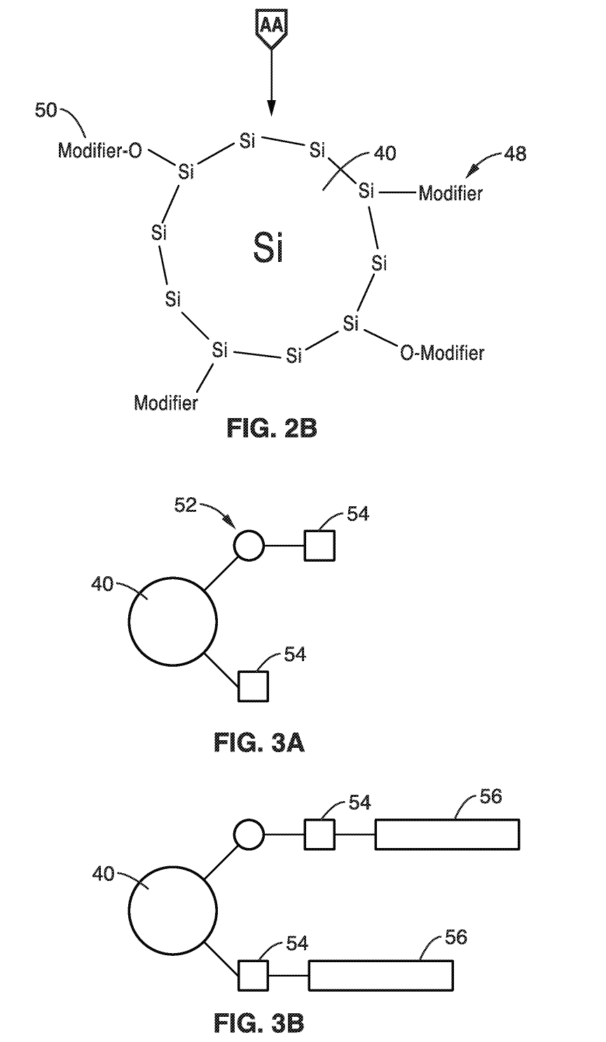

The particle surface functionalization subsystem of the method can take a variety of forms. The simple modification of the available hydrogen or hydroxyl groups is shown in FIG. 3A. The silicon particle 40 may have a modifier 54 that is coupled directly or through the oxygen 52 of a hydroxyl. The same modifier 54 is coupled to both potential reaction sites in the embodiment shown in FIG. 3A. Although the same modifier 54 is shown to illustrate one material, it can be seen that a second modifier could be used in addition to modifier 54 so that two modifiers are present on the particle 40.

The modifier 54 molecule can be a wide variety of materials such as a metal, a non-metal or an organic molecule that has a desired chemical or biological activity. For example, the particle surfaces can be modified to generate properties favorable for analytical, diagnostic, detection (including imaging) and therapeutic purposes. In one embodiment, this is accomplished by attaching agents and/or materials that can capture metals and metal compounds to the surface of the SiQDs. Such agents include amines, diamines, triamines and polyamines; phosphines, diphosphines, triphosphines and polyphosphines; thiols, dithiols, trithiols and polythiols etc.

In another embodiment, the attached modifiers 54 are materials that can capture acidic or basic entities. Examples are amines, diamines, triamines and polyamines; phosphines, diphosphines, triphosphines and polyphosphines; thiols, dithiols, trithiols and polythiols, boron containing compounds, aluminum containing compounds and molecules containing ketone or imine functionalities.

In a further adaptation, the modifiers 54 that are attached to particle surfaces are atoms or groups of atoms that can serve as absorbers and/or emitters of light to enhance detection in a variety of environments.

In another embodiment, the modifiers 54 are atoms or groups of atoms with biological activity that can reduce or enhance toxicity towards a variety of materials ranging from molecules or materials toxic to living organisms to molecules or materials with therapeutic properties towards a variety of diseases or ailments. These attachments could include surfactants, proteins, lipoproteins etc.

The modifier 54 molecule can also be linear or branched carbon compounds such as alkanes, alkenes and alkynes as well as aromatic compounds, substituted aromatic compounds and organoheteroatoms.

Modification of the particle surfaces can be as simple as heating the silicon nanoparticles 40 and the surface modifier 54 in a suitable solvent for time periods ranging from 1-5 hours. However, other modifications may be much more complicated. The desired modifier may not be a good candidate for reactions with the hydrogen or hydroxyl groups on the silicon particle surface. As shown in FIG. 3B, a second modifier 56 molecule with the desired activity may be coupled to the first modifier 54 that is joined to the silicon particle 40 to provide functionality. For example, the intermediate modifier 54 may be a metal atom that reacts easily with the second modifier 56 to couple the active modifier 56 to the silicon structure through the intermediate modifier molecule 54.

The second modifier 56 typically has the chemical, optical or biological activity rather than the intermediate modifier 54. However, in one embodiment, the intermediate modifier 54 can have one type of activity and the second modifier 56 can have a second type of activity. Similarly, more than one type of second modifier 56 can be used to provide two modifications with complementary activity.

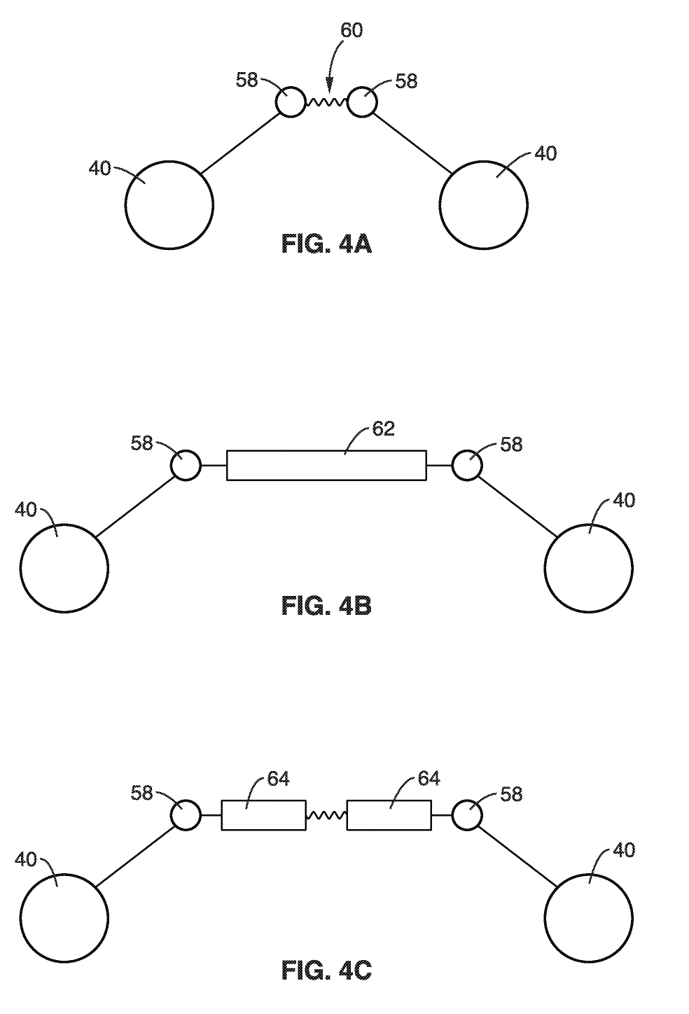

The silicon particle surfaces can also be modified to produce linking between particles as shown in alternative illustrations in FIG. 4A through FIG. 4C. The hydrogen or hydroxyl groups of the silicon particles 40 can be modified with a modifier 58 that is capable of coupling 60 with another modifier 58 from a second silicon particle 40 such as an organic, inorganic and organoheteroatom linkers. The coupling 60 of the particles may produce an agglomeration of particle or a porous thin film of linked particles.

In the alternative embodiment shown in FIG. 4B, the particles 40 can link directly or through a modifier 58 to opposing ends of a bridge or spacer 62. For example, the linkages could form on the surfaces of SiQD particles resulting in the following type of bonding arrays on the surfaces of two or more SiQDs: 1) Si-L-Si; 2) SiO-L-Si; and 3) SiO-L-OSi, in which Si is a silicon atom on the surface of a SiQD, 0 is an oxygen atom, and L represents a linking agent 62.

Multiple bridges 62 will link the particles 40 together to form porous films or clusters. The characteristics of the films or clusters can be determined by the size or length of the bridge 62 as well as the concentration of bridges used with respect to the number of nanoparticles. The bridge 62 can also be structured to have some separate chemical or biological activity in addition to the linking function.

Similarly, the particles 40 can be linked with a mechanism of joining linking agents 64 together to form the bridge or spacer. In the embodiment shown in FIG. 4C, the hydrogen or hydroxyl groups of silicon particle 40 are coupled to a linker 64 either directly or through a first modifier 58. The linker 64 of each particle 40 join together to form a bridge or spacer between particles. In one embodiment, the linkers 64 are not identical but are two complimentary molecules that are capable of linking together. In another embodiment, the particles 40 have different sizes or surface characteristics. Aggregations of particles of different sizes and surface functionalities can be designed and formed.

There is a wide range of linking or modifying agents that can be used as the modifier 58, the bridge 62 or the linker 64 molecules. These linking agents can also be modified to have some chemical, biological or optical activity or characteristics as well as performing the linking function.

Organic linking agents can include alkanes, alkenes and alkynes attached to aromatic compounds such as benzene, naphthalene and other polyaromatics as well as nitrogen and sulfur containing aromatic and non-aromatic heterocycles.

In another embodiment, the selected linking agents are thiols, diols, triols and polyols (in the family of alcohols) with hydrocarbon attachments that are saturated and unsaturated such as methyl, methylene, ethyl, ethylene, etc., with a range of C1 through C100.

Other suitable organic agents include amines, diamines, triamines, and polyamines with saturated and/or unsaturated hydrocarbon attachments, such as methyl, methylene, ethyl, ethylene, etc., with a range of C1 through C100.

Further organic linking agents include phosphines, diphosphines, triphosphines and polythiols with saturated and/or unsaturated hydrocarbon attachments, such as methyl, methylene, ethyl, ethylene, etc., with a range of C1 through C100.

Ketones, diketones, triketones and polyketones with hydrocarbon attachments, saturated and unsaturated such as methyl, methylene, ethyl, ethylene, etc., with a range of C1 through C100 are also suitable organic linking agents.

Likewise, aldehydes, dialdehydes, trialdehydes and polyaldehydes with hydrocarbon attachments, saturated and unsaturated, such as methyl, methylene, ethyl, ethylene, etc., with a range of C1 through C100 are also suitable linkers.

There is also a wide variety of inorganic linking agents that are suitable. For example the linking agent can be a metal atom or atoms brought to the surface to react with silicon atoms, or functionalized silicon atoms or that can react with two or more SiQDs to link the SiQDs as illustrated in FIG. 4A.

In another embodiment, the inorganic linking or reactive agent is a metal atom or atoms with groups attached to the metal atom or atoms that may or may not form additional bonds to the silicon surface brought to the surface to react with silicon atoms, or functionalized silicon atoms or that can react with two or more SiQDs to link the SiQDs, for example.

Alternatively, the inorganic linking agent can be a nonmetal atom or atoms that are brought to the surface to react with silicon atoms, or functionalized silicon atoms on that can react with two or more SiQDs to link the SiQDs.

In a further embodiment, the inorganic linking agent is a nonmetal atom or atoms with groups attached to the metal atom or atoms that may or may not form additional bonds to the silicon surface brought to the surface to react with silicon atoms, or functionalized silicon atoms or that can react with two or more SiQDs to link the SiQDs.

Another group of suitable linking agents are organoheteroatom linking agents. These include any of the above groups that are also attached to elements such as silicon, germanium, tin or lead as well as the metals of the transition series, lanthanide series or actinide series. Typical examples would be alkenyl and alkynyl groups attached to silicon, alkenyl and alkynyl groups attached to phosphorus, alkenyl and alkynyl groups attached to sulfur, alkenyl and alkynyl groups attached to iron.

Accordingly, the silicon particles can be functionalized with a wide range of modifiers to provide specific chemical, biological or linking activities or aggregates or porous films. The physiochemical properties of functionalized and sized silicon nanoparticles like SiQDs will imbue this material with characteristics that can be used to make new diagnostic sensors, assays, and other high valued products. For example, functionalized SiQDs may be useful in certain biomedical diagnostics or environmental tests such as measure acidity and basicity levels or detecting heavy metals on a selective basis as well as certain nonmetals known to be toxic, e.g., certain organic molecules that are known contaminants of soil and water (e.g., contaminants like those found in waste sites located in or near oil and gas production sites or various contaminants or other substances in landfills).

The invention may be better understood with reference to the accompanying examples, which are intended for purposes of illustration only and should not be construed as in any sense limiting the scope of the present invention as defined in the claims appended hereto.

### Example 1

To demonstrate the gas phase pyrolysis synthesis, distillation and purification of Si-QDs, an apparatus shown in FIG. 1A and FIG. 1B was set up and tested. Neat Cyclohexasilane (Si₆H₁₂) was controllably injected (0.1 mL/h feed rate) using a syringe pump into an ultrasonic horn atomizer (Sonotek Inc, Milton, N.Y.) operating at 120 kHz. For efficient aerosol mist formation and transport to the reactor, Helium (He, 99.999%, Praxair) flowing at 50 sccm was introduced. An additional sheath gas of helium (He) flowing at 125 sccm was used to improve the vaporization of the mist and to carry the precursor to the hot-zone. The sheath gas surrounded the precursor at a distance of 2.5 cm ahead of the hot-zone. A 30 cm long fused silica tube with an outer diameter of 1.27 cm was used to form the reactor. Coil heaters of length 5 cm and inner diameter of 1.3 cm was slid over the fused silica tube to form the reactor. The length of the reactor (6 cm or 12 cm) was adjusted by using one or two coil heater(s) adjacent to each other over the fused silica tube. The temperature distribution in the reactor was controlled by varying the reactor length and applied power. The effects of reactor lengths (6 cm and 12 cm) on the properties of Si-QDs that were produced were recorded and evaluated. The temperature profiles corresponding to the reactor lengths of 6 cm and 12 cm were evaluated as shown in FIG. 5.

The produced Si-QDs in the gas phase were collected by bubbling it through a mesitylene and 1-dodecene (5:1. Vol. %) solution (total 12 mL) contained in a glass vial. Replacing the bubbler with a frit filter or steel mesh facilitated the collection of dry as-synthesized Si-QDs.

The as-synthesized Si-QDs dispersed in the mesitylene:1-dodecene mixture were then thermally hydrosilylated at 210±5° C. for 12 h. After hydrosilylation, the residual solvent was slowly evaporated at 120° C., resulting in a waxy solid. Sample 1 was colorless whereas Sample 2 was yellow in color. These solids were dispersed in spectroscopic grade hexane for structural and optical analyses.

With a constant precursor feed-rate and by varying the lengths of the hot-zone, two distinct Si-QDs can be synthesized. For shorter hot-zone residence times, Si-QDs with no crystalline features were observed. For longer hot-zone residence times, Si-QDs of ˜2.0 nm with significant crystallinity can be produced. This observation suggests that an increase in the length of reactor helps not only results in increasing the Si-QDs size that are produced, but will also increase the order (amorphous to crystalline). Consequently, the method may allow the synthesis Si-QDs with different sizes and structures, by suitably engineering the precursor feed-rate and the temperature profile of the hot-zone.

### Example 2

In order to characterize the size and structure of the as-synthesized Si-QDs that were produced, the silicon particles were evaluated with Raman spectroscopy and high-resolution transmission electron microscopic (HRTEM) analysis.

Dry as-synthesized Si-QDs collected on a glass frit were applied to glass slides and analyzed by Raman spectroscopy. Raman spectroscopic analysis was performed using a Horiba Jobin Yvon Labram Aramis confocal imaging system with a 532 nm Nd:YAG laser source. The dry as-synthesized and passivated (waxy solid) Si-QDs were applied to a glass substrate and Raman spectra were collected.

Deconvoluted spectra of Si peaks corresponding to Samples 1 and 2 that were obtained. The characteristic Si regions in the Raman spectra were deconvoluted to determine the contribution arising from amorphous and crystalline phases present in the samples.

The Raman spectra that were obtained showed bands centered at 460 and 490 cm⁻¹. The broad band at 460 cm⁻¹ was attributed to amorphous Si while the band at 490 cm⁻¹ could be arising from disordered or intermediate (between amorphous and crystalline) Si. The deconvoluted Raman spectra depicted two characteristic bands centered at 490 and 510 cm⁻¹ corresponding to amorphous or intermediate and nanocrystalline Si phases respectively, where the contribution from nc-Si is significantly higher than the other phase. The characteristic Si peaks for bulk c-Si, microcrystalline, and nano-crystalline Si are observed at 521, 518 and 512 cm⁻¹ respectively, while, for free standing Si-NCs and porous Si-NCs, the Si peak is expected at 505-510 cm⁻¹.

Raman spectral features of freestanding amorphous Si-QDs are reported to show no significant change with size and its surface state, but Raman features of crystalline Si-QDs provide details regarding the QD size and the surface state. Accordingly, the Si-NCs of less than 3 nm that are surface passivated with hydrocarbons exhibit Raman signature bands at 510 cm⁻¹. On the other hand, QDs of the same size but covered with surface oxide will exhibit features at ˜515 cm⁻¹. The presence of a Si band at 510 cm⁻¹ in Sample 2 confirmed the nc-Si structure of the SiQDs. Based on this data it was concluded that Samples 1 and 2 are predominantly a-Si-QDs and Si-NCs, respectively.

The bright field HRTEM image of Sample 2 which showed the presence of Si-NCs that were 1.7-2.4 nm in diameter. The average crystallite size of Si-NCs was determined to be 2.0±0.2 nm.

X-ray diffraction spectra of Sample 1 of the dry Si-QDs showed no crystalline features, while Sample 2 showed broad peaks at 28.5° and 47.4° corresponding to Si (111) and Si (220) orientations, respectively. The crystalline grain size of Si-QDs Sample 2 was determined to be 2.3 nm.

### Example 3

Further characterization of the chemical structures of the as-synthesized Si-QDs that were produced was conducted with Fourier transform infrared spectroscopy (FTIR). The types of Si-H bonds and the effects of hydrosilylation on the surfaces of the as-synthesized (dry powder) and passivated (waxy solid without solvent) Si-QDs were evaluated using FTIR.

During hydrosilylation, 1-dodecene reacts with the surface SiHₓ of Si-QDs to form stable Si-C covalent bonds. The FTIR spectra of the as-synthesized Si-QDs from Sample 1 demonstrated predominantly SiH₃, SiH₂ and SiH absorptions, while the hydrosilylated Si-QDs from Sample 1 depicted strong SiH (bulk and surface) features along with the bands corresponding to dodecane functionalities. The intensities of ═CH₂ and C═C vibrations (at 3200, 1650, 900 and 800 cm⁻¹) of hydrosilylated a-SiQDs were insignificant compared with the neat 1-dodecene.

The as-synthesized and passivated Si-QDs synthesized using the 10 cm hot-zone (Sample 2) show spectral features similar to as-synthesized and passivated Si-QDs corresponding to Sample 1.

The Si-Hr absorption bands of as-synthesized and hydrosilylated Si-QDs corresponding to samples 1 and 2 (1950-2220 cm⁻¹) were deconvoluted to determine contributions arising from individual SiHₓ (x=1, 2 & 3) functionalities. The SiHₓ vibrations in Si-QDs may arise from the surface, from the bulk, or from both depending on the morphology and hydrogen content.

In hydrosilylated Si-QDs, SiH surface and bulk absorptions at 2090 cm⁻¹ and 2065 cm⁻¹, respectively, are noticeably more intense than SiH₃ and SiH₂ vibrations. The absorption at 2000-2060 cm⁻¹ can also be assigned to SiH vibrations from H₂SiSiH and/or H₃SiSiH species, which are generally present in the bulk of a-Si clusters. In the hydrosilylated Si-QDs, stable covalent bond formation occurring at the surface of Si-QDs and the presence of —SiH bulk absorption suggest that a significant fraction of hydrogen is present in the bulk of both samples of Si-QDs. It is also possible that the inefficient hydrosilylation of Si-QDs would not modify all of the hydrogen terminated Si on the surface of Si-QDS, but, since the assignments of Si-H vibrations correspond more to the bulk Si-H vibrations, it is more likely that these Si-QDs have hydrogen in its bulk.

### Example 4

To understand the optical absorbance of the Si-QDs, UV-Vis spectroscopic analysis of hydrosilylated Si-QDs (Sample 1 and Sample 2) dispersed in spectroscopic grade hexane) was performed. Absorption spectra were recorded using a UV-Vis spectrophotometer (Agilent's Cary 300 UV-Vis). Emission spectra were recorded using Horiba Jobin Yvon Fluorolog-3 spectrofluorimeter. All photophysical experiments were carried out at room temperature in a quartz cuvette with path length of 1 cm, and slit widths optimized at 2 nm. Emission lifetimes were measured using a pulsed diode light source (NanoLED 300 nm, <1 ns pulse width and 340 nm, <1 ns pulse width). The decay curves were fitted using standard exponential fits (two and three). The goodness of the fit was judged using the χ² values (1±0.1) and the residual plot.

The optical absorption characteristics of a-Si-QDs indicate that Sample 1 absorbs in the UV region below 300 nm, with a shoulder in the absorbance curve at approximately 251 nm, while Sample 2 absorbed below approximately 375 nm with multiple absorption shoulders at 271 nm, 282 nm and 292 nm. The optical absorbance characteristics of Sample 1 were similar to the reported Si-QDs consisting amorphous phase (or nanocrystals embedded in amorphous Si), while for Sample 2, the absorption characteristics suggested the presence of direct band-gap transitions arising from Si-NCs that are 1.5 nm to d2.3 nm in size.

The PL spectra of the Si-QD samples excited at 300 nm were examined. A PL emission maxima 370-372 nm was observed for samples 1 and 2. PL spectra of both the samples are similar, except that Sample 2 exhibits additional characteristic spectral features at 403, 425 and 457 nm. The PL emission wavelengths correspond to near-UV (NUV), violet and near-blue.

The size, structure, composition and surface state of the Si-QDs was shown to determine the PL emission characteristics. Si-NCs with diamond cubic lattice structure with sizes from 2 to 10 nm emit in green to NIR, while the Si-NCs that are smaller than 2.0 nm exhibit emission in aqua/blue to NUV. Amorphous hydrogenated Si-QDs [a-Si-QDs] that are free-standing, embedded in a dielectric, or in an a-Si:H matrix are also reported to exhibit aqua/blue to NUV. For a definite QD size, the disorders in the amorphous Si-QDs are predicted to cause additional states in the band-gap when compared with their crystalline counterparts. With decreasing dot size, a blue shift in the PL emission occurs in Si-QDs.

Tuning the emission properties of Si-NCs in NUV-blue can be accomplished by control of the crystallite size and maximum surface passivation. Using a tight-binding scheme it was determined that Si-NCs <2.0 nm are expected to provide PL emissions in the NUV and blue regions. It has been shown that Si-NCs with a diameter 1.8 nm have an emission maximum at 335 nm when excited at 290 nm. It has also been demonstrated that Si-NCs of diameter 1.8 nm to 2.7 nm that are capped with organic molecules exhibit PL emission in 290 nm to 340 nm. Some recent results show that the surface oxide layer on 2.0 nm and smaller Si-NCs could be responsible for the blue to NUV emission. However, changes in the emission peak position with different excitation in such Si-NCs are not expected in Si-QDs that are covered with surface oxide.

Sample 2 was excited at different wavelengths (275 nm to 350 nm) and the PL emission spectra were collected. Sample 2 depicted a PL emission maxima at 370 nm to 372 nm. The PL emissions (maxima) were red-shifted with increasing the wavelengths of the excitation. Similar characteristics were also observed for Sample 1, confirming that the origin of PL is from the direct band gap of Si-QDs ruling out the presence of oxygen in the sample.

In addition to the features arising from the Si-NCs, Sample 2 exhibited a small 2-3 nm red shift in the main PL emission peak compared to Sample 1. This could be due to a-Si-QDs or an amorphous Si shell that may be present in the sample. Thus, it appears that Sample 2 is composed of mainly Si-NCs that are approximately 1.8 nm to 2.0 nm and small amounts of a-Si, while Sample 1 is made of only a-Si.

Accordingly, as the physiochemical properties of SiQDs can be designed for specific applications, SiQDs can play a pivotal role in the design and production of improved biosensors, multimodal imaging agents, and biomedical diagnostics. Furthermore, SiQDs have the potential for enhancing drug delivery, generating new medical therapies, and augmenting other important products and commercial applications such as more versatile environmental and toxicological tests for oil and gas exploration and production.

From the description herein, it will be appreciated that that the present disclosure encompasses multiple embodiments which include, but are not limited to, the following:

1. A method for producing functionalized silicon nanoparticles, comprising: (a) controlling the size of aerosolized droplets of a liquid silane composition within a range of droplet diameters of between 0.5 nm and 200 nm; (b) pyrolysing the droplets to produce silicon nanoparticles with a plurality of hydrogen or hydroxyl groups attached to surface silicon atoms of the nanoparticles; and (c) coupling one or more class of reactive molecules to the hydrogen or hydroxyl groups thereby functionalizing the outer surfaces of the nanoparticles.

2. The method of any preceding embodiment, wherein the liquid silane composition is a silane selected from the group of silanes consisting of cyclopentasilane (CPS), neopentasilane (NPS), and cyclohexasilane (CHS) and mixtures thereof.

3. The method of any preceding embodiment, wherein the reactive molecule is an organic linking agent comprising: a saturated or unsaturated hydrocarbon bridge with a range of C1 through C100; and an alcohol connected to the bridge selected from the group alcohols consisting of a thiol, a diol, a triol and a polyol.

4. The method of any preceding embodiment, wherein the reactive molecule is an organic linking agent comprising: a saturated or unsaturated hydrocarbon bridge with a range of C1 through C100; and an amine connected to the bridge selected from the group of amines consisting of a primary amine, a diamine, a triamine, and a polyamine.

5. The method of any preceding embodiment, wherein the reactive molecule is an organic linking agent comprising: a saturated or unsaturated hydrocarbon bridge with a range of C1 through C100; and a compound connected to the bridge selected from the group of compounds consisting of a phosphine, a diphosphine, a triphosphine and a polyphosphine.

6. The method of any preceding embodiment, wherein the reactive molecule is an organic linking agent comprising: a saturated or unsaturated hydrocarbon bridge with a range of C1 through C100; and a compound connected to the bridge selected from the group of compounds consisting of a ketone, a diketone, a triketone and a polyketone.

7. The method of any preceding embodiment, wherein the reactive molecule is an organic linking agent comprising: a saturated or unsaturated hydrocarbon bridge with a range of C1 through C100; and a compound connected to the bridge selected from the group of compounds consisting of an aldehyde, a dialdehyde, a trialdehyde and a polyaldehyde.

8. The method of any preceding embodiment, wherein the reactive molecule is an organic linking agent comprising: an alkene or alkyne bridge; and a compound connected to the bridge selected from the group of compounds consisting of an aromatic compound, a nitrogen or sulfur substituted aromatic compound and a non-aromatic heterocyclic compound.

9. The method of any preceding embodiment, wherein the reactive molecule comprises metal atoms capable of reacting with silicon atoms, silicon hydride, or hydroxyl groups of the silicon nanoparticles and thereby link two or more nanoparticles together.

10. The method of any preceding embodiment, wherein the metal is selected from the group of metals consisting of silicon, germanium, tin and lead.

11. The method of any preceding embodiment, wherein the metal is selected from the group of metals consisting of metals of the transition series, the lanthanide series and the actinide series of metals.

12. The method of any preceding embodiment, further comprising: an organic spacer coupled to the metal atoms; wherein the metal atoms on the surfaces of two nanoparticles are linked by the spacer.

13. The method of any preceding embodiment, wherein the spacer comprises an organoheteroatom spacer with at least one carbon in the backbone of the molecular structure replaced by a non-carbon atom.

14. The method of any preceding embodiment, wherein the reactive molecule comprises nonmetal atoms capable of reacting with silicon atoms or hydroxyl groups of the silicon nanoparticles and thereby link two or more nanoparticles together.

15. The method of any preceding embodiment, further comprising: an organic spacer coupled to the nonmetal atoms; wherein the nonmetal atoms on the surfaces of two nanoparticles are linked by the spacer.

16. The method of any preceding embodiment, wherein the spacer comprises an organoheteroatom spacer with at least one carbon in the backbone of the molecular structure replaced by a non-carbon atom.

17. The method of any preceding embodiment, wherein the reactive molecule comprises a compound configured to capture metals and metal compounds selected from the group of compounds consisting of an amine, a diamine, a triamine and a polyamine.

18. The method of any preceding embodiment, wherein the reactive molecule comprises a compound configured to capture metals and metal compounds selected from the group of compounds consisting of a phosphine, a diphosphine, a triphosphine and a polyphosphine.

19. The method of any preceding embodiment, wherein the reactive molecule comprises a compound configured to capture metals and metal compounds selected from the group of compounds consisting of a thiol, a dithiol, a trithiol and a polythiol.

20. The method of any preceding embodiment, wherein the reactive molecule comprises a compound configured to capture acidic or basic entities selected from the group of compounds consisting of a thiol, a phosphine, an amine, a boron containing compound, an aluminum containing compound and molecules containing ketone or imine functionalities.

21. A method for producing functionalized silicon nanoparticles, comprising: (a) controlling the size of aerosolized droplets of a liquid silane composition within a range of droplet diameters of between 0.5 nm and 200 nm; (b) pyrolysing the droplets to produce silicon nanoparticles with a plurality of hydrogen or hydroxyl groups attached to surface silicon atoms of the nanoparticles; (c) functionalizing outer surfaces of the nanoparticles with linking molecules bound to the hydrogen or hydroxyl groups on the outer surfaces of the nanoparticles; and (d) coupling the linking molecules of the nanoparticles to link the silicon nanoparticles together to form an aggregate structure.

22. The method of any preceding embodiment, wherein the linking molecule comprises metal atoms capable of reacting with silicon atoms, silicon hydride, or hydroxyl groups of the silicon nanoparticles and thereby link two or more nanoparticles together.

23. The method of any preceding embodiment, wherein the metal is selected from the group of metals consisting of silicon, germanium, tin and lead.

24. The method of any preceding embodiment, wherein the metal is selected from the group of metals consisting of metals of the transition series, the lanthanide series and the actinide series of metals.

25. The method of any preceding embodiment, further comprising: an organic spacer coupled to the metal atoms; wherein the metal atoms on the surfaces of two nanoparticles are linked by the spacer.

26. A method for producing functionalized silicon nanoparticles, comprising: (a) controlling the size of aerosolized droplets of a liquid silane composition within a range of droplet diameters of between 0.5 nm and 200 nm; (b) pyrolysing the droplets to produce silicon nanoparticles with a plurality of hydrogen or hydroxyl groups attached to surface silicon atoms of the nanoparticles; (c) coupling bridge molecules to hydrogen or hydroxyl groups on the outer surfaces of the nanoparticles at a first end of the bridge molecule; and (d) coupling hydrogen or hydroxyl groups of the outer surfaces of the nanoparticles to a second end of the bridge molecule to form an aggregate structure.

27. The method of any preceding embodiment, wherein the bridge comprises a molecule selected from the group of molecules consisting of an alkane, an alkene and an alkyne.

28. The method of any preceding embodiment, further comprising: coupling one or more class of reactive molecules to the bridge thereby functionalizing the bridge and the aggregate of nanoparticles.

29. The method of any preceding embodiment, wherein the reactive molecules of the bridge comprises a molecule selected from the group of molecules consisting of an alcohol, an amine, a phosphine, a ketone, and an aldehyde.

30. The method of any preceding embodiment, wherein the reactive molecule of the bridge is a metal selected from the group of metals consisting of silicon, germanium, tin and lead.

31. The method of any preceding embodiment, wherein the reactive molecule of the bridge is a metal selected from the group of metals consisting of the transition series, the lanthanide series and the actinide series of metals.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

In the claims, reference to an element in the singular is not intended to mean “one and only one” unless explicitly so stated, but rather “one or more.” All structural, chemical, and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A method for producing functionalized silicon nanoparticles, comprising:
(a) controlling the size of aerosolized droplets of a liquid silane composition within a range of droplet diameters of between 0.5 nm and 200 nm;
(b) pyrolysing the droplets to produce silicon nanoparticles with a plurality of hydrogen or hydroxyl groups attached to surface silicon atoms of the nanoparticles; and
(c) coupling one or more class of reactive molecules to the hydrogen or hydroxyl groups thereby functionalizing the outer surfaces of the nanoparticles.

2. The method of claim 1, wherein said liquid silane composition is a silane selected from the group of silanes consisting of cyclopentasilane (CPS), neopentasilane (NPS), and cyclohexasilane (CHS) and mixtures thereof.

3. The method of claim 1, wherein said reactive molecule is an organic linking agent comprising:
a saturated or unsaturated hydrocarbon bridge with a range of C1 through C100; and
an alcohol connected to the bridge selected from the group of alcohols consisting of a diol, a triol and a polyol.

4. The method of claim 1, wherein said reactive molecule is an organic linking agent comprising:
a saturated or unsaturated hydrocarbon bridge with a range of C1 through C100; and
a thiol connected to the bridge selected from the group of thiols consisting of a dithiol, a trithiol and a polythiol.

5. The method of claim 1, wherein said reactive molecule is an organic linking agent comprising:
a saturated or unsaturated hydrocarbon bridge with a range of C1 through C100; and
an amine connected to the bridge selected from the group of amines consisting of a primary amine, a diamine, a triamine, and a polyamine.

6. The method of claim 1, wherein said reactive molecule is an organic linking agent comprising:
a saturated or unsaturated hydrocarbon bridge with a range of C1 through C100; and
a compound connected to the bridge selected from the group of compounds consisting of a phosphine, a diphosphine, a triphosphine and a polyphosphine.

7. The method of claim 1, wherein said reactive molecule is an organic linking agent comprising:
a saturated or unsaturated hydrocarbon bridge with a range of C1 through C100; and
a compound connected to the bridge selected from the group of compounds consisting of a ketone, a diketone, a triketone and a polyketone.

8. The method of claim 1, wherein said reactive molecule is an organic linking agent comprising:
a saturated or unsaturated hydrocarbon bridge with a range of C1 through C100; and
a compound connected to the bridge selected from the group of compounds consisting of an aldehyde, a dialdehyde, a trialdehyde and a polyaldehyde.

9. The method of claim 1, wherein said reactive molecule is an organic linking agent comprising:
an alkene or alkyne bridge; and
a compound connected to the bridge selected from the group of compounds consisting of an aromatic compound, a nitrogen or sulfur substituted aromatic compound and a non-aromatic heterocyclic compound.

10. The method of claim 1, wherein said reactive molecule comprises metal atoms capable of reacting with silicon atoms, silicon hydride, or hydroxyl groups of the silicon nanoparticles and thereby link two or more nanoparticles together.

11. The method of claim 10, wherein said metal is selected from the group of metals consisting of silicon, germanium, tin and lead.

12. The method of claim 10, wherein said metal is selected from the group of metals consisting of metals of the transition series, the lanthanide series and the actinide series of metals.

13. The method of claim 10, further comprising:
an organic spacer coupled to the metal atoms;
wherein the metal atoms on the surfaces of two nanoparticles are linked by the spacer.

14. The method of claim 13, wherein the spacer comprises an organoheteroatom spacer with at least one carbon in the backbone of the spacer replaced by a non-carbon atom.

15. The method of claim 1, wherein said reactive molecule comprises nonmetal atoms capable of reacting with silicon atoms or hydroxyl groups of the silicon nanoparticles and thereby link two or more nanoparticles together.

16. The method of claim 15, further comprising:
an organic spacer coupled to the nonmetal atoms;
wherein the nonmetal atoms on the surfaces of two nanoparticles are linked by the spacer.

17. The method of claim 16, wherein the spacer comprises an organoheteroatom spacer with at least one carbon in the backbone of the spacer replaced by a non-carbon atom.

18. The method of claim 1, wherein said reactive molecule comprises a compound configured to capture metals and metal compounds selected from the group of compounds consisting of an amine, a diamine, a triamine and a polyamine.

19. The method of claim 1, wherein said reactive molecule comprises a compound configured to capture metals and metal compounds selected from the group of compounds consisting of a phosphine, a diphosphine, a triphosphine and a polyphosphine.

20. The method of claim 1, wherein said reactive molecule comprises a compound configured to capture metals and metal compounds selected from the group of compounds consisting of a thiol, a dithiol, a trithiol and a polythiol.

21. The method of claim 1, wherein said reactive molecule comprises a compound configured to capture acidic or basic entities selected from the group of compounds consisting of a thiol, a phosphine, an amine, a boron containing compound, an aluminum containing compound and molecules containing ketone or imine functionalities.

22. A method for producing functionalized silicon nanoparticles, comprising:
(a) controlling the size of aerosolized droplets of a liquid silane composition within a range of droplet diameters of between 0.5 nm and 200 nm;
(b) pyrolysing the droplets to produce silicon nanoparticles with a plurality of hydrogen or hydroxyl groups attached to surface silicon atoms of the nanoparticles;
(c) functionalizing outer surfaces of the nanoparticles with linking molecules bound to the hydrogen or hydroxyl groups on the outer surfaces of the nanoparticles; and
(d) coupling the linking molecules of the nanoparticles to link the silicon nanoparticles together to form an aggregate structure.

23. The method of claim 22, wherein said linking molecule comprises metal atoms capable of reacting with silicon atoms, silicon hydride, or hydroxyl groups of the silicon nanoparticles and thereby link two or more nanoparticles together.

24. The method of claim 23, wherein said metal is selected from the group of metals consisting of silicon, germanium, tin and lead.

25. The method of claim 23, wherein said metal is selected from the group of metals consisting of metals of the transition series, the lanthanide series and the actinide series of metals.

26. The method of claim 23, further comprising:
an organic spacer coupled to the metal atoms;
wherein the metal atoms on the surfaces of two nanoparticles are linked by the spacer.

27. A method for producing functionalized silicon nanoparticles, comprising:
(a) controlling the size of aerosolized droplets of a liquid silane composition within a range of droplet diameters of between 0.5 nm and 200 nm;
(b) pyrolysing the droplets to produce silicon nanoparticles with a plurality of hydrogen or hydroxyl groups attached to surface silicon atoms of the nanoparticles;
(c) coupling bridge molecules to hydrogen or hydroxyl groups on the outer surfaces of the nanoparticles at a first end of the bridge molecule; and
(d) coupling hydrogen or hydroxyl groups of the outer surfaces of the nanoparticles to a second end of the bridge molecule to form an aggregate structure.

28. The method of claim 27, wherein said bridge comprises a molecule selected from the group of molecules consisting of an alkane, an alkene and an alkyne.

29. The method of claim 27, further comprising:
coupling one or more class of reactive molecules to the bridge thereby functionalizing the bridge and the aggregate of nanoparticles.

30. The method of claim 29, wherein said reactive molecules of said bridge comprises a molecule selected from the group of molecules consisting of an alcohol, an amine, a phosphine, a ketone, and an aldehyde.

31. The method of claim 29, wherein said reactive molecule of the bridge is a metal selected from the group of metals consisting of silicon, germanium, tin and lead.

32. The method of claim 29, wherein said reactive molecule of the bridge is a metal selected from the group of metals consisting of the transition series, the lanthanide series and the actinide series of metals.
